(19) United States
(12) Patent Application Publication
(10) Pub. No.: US 2007/0064311 A1
(43) Pub. Date: Mar. 22, 2007

(54) Head mounted projector display for flat and immersive media

(76) Inventor: Brian Vandellyn Park, Austin, TX (US)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/499,259

(22) Filed: Aug. 4, 2006

Related U.S. Application Data
(60) Provisional application No. 60/705,727, filed on Aug. 5, 2005.

(51) Int. Cl. G02B 27/14

(52) U.S. Cl. 359/630

(57) ABSTRACT

A head mounted display system is described. The head mounted display system may include a frame. The frame may be coupled to a head of a user. A projector head may be coupled to the frame. The projector head may provide an image. A screen may be coupled to the frame. The screen may display the image to the user. The image displayed on the screen may be a stereoscopic image. The screen may display the image with a field of view of at least about 120° and/or HDTV resolution to the user. A mirror may be coupled to the frame. The mirror may reflect the image provided by the projector head onto the screen. Optics may allow the user's eyes to focus on the image displayed on the screen.

### PRIORITY CLAIM

This application claims priority to U.S. Provisional Patent Application No. 60/705,727 entitled “Head Mounted Projector Display for Flat and Immersive Media” filed on Aug. 5, 2005.

### BACKGROUND

1. Field of the Invention

The present invention relates generally to head mounted projector display systems. Certain embodiments relate to head mounted projector display systems for displaying flat and/or immersive media.

2. Description of Related Art

Projector based display systems have been under development for use in, for example, video games, training sessions, simulations, remote control applications, privacy viewing and entertainment systems, and/or immersive telepresence applications. Display systems may be used with either video or computer imaging systems. Video game systems such as Xbox 360® (Microsoft Corp. (Redmond, Wash.)) and Playstation 3® (Sony Electronics, Inc. (Japan)) that are able to provide games rendered in real time may use projector display systems. Immersive telepresence applications include remote control and/or manipulation of robots in spacecraft, on the moon, and/or on other planets. Immersive telepresence applications also include live events such as video game competitions, interactive video game competitions, sporting events, concerts, business meetings, or news events. Immersive telepresence applications may use remote video systems to facilitate control of the robots.

U.S. Pat. No. 5,695,406 to Park, which is incorporated by reference as if fully set forth herein, describes an immersive cyberspace system. The described system provides visual, audible, and vibrational inputs to a subject remaining in neutral immersion and also provides for subject control input. The described system includes a relaxation chair and a neutral immersion display hood. The relaxation chair supports a subject positioned thereupon and places the subject in a position which merges a neutral body position, the position a body naturally assumes in zero gravity, with a savasana yoga position. The display hood, which covers the subject's head, is configured to produce light images and sounds. An image projection subsystem provides either external or internal image projection. The display hood includes a projection screen moveably attached to an opaque shroud. An external computer, coupled to various components of the immersive cyberspace system, executes a software program and creates the cyberspace environment. One or more neutral hand posture controllers may be coupled to the external computer system and used to control various aspects of the cyberspace environment or to enter data during the cyberspace experience.

High-definition television (HDTV) has become a standard display format. Projectors and large displays utilizing HDTV are common in the marketplace. Current development is focused on developing smaller (e.g., miniature) projectors. These new projectors may utilize LEDs (light emitting diodes) or lasers as light sources. Smaller projectors may allow for head mounting the projectors without the projectors being cumbersome to the user.

Currently HDTV is commonly viewed as flat media. Flat media presents a flat image to the user with defined edges or cut-off points in the images. Typical examples of flat media systems include, but are not limited to, flat panel LCD TVs and monitors, flat panel plasma screen TVs, and home theater projectors. Video games, DVDs, and/or HDTV are commonly viewed on flat media systems.

Immersive media is a newer area of development for displaying images to a user. Immersive media engages the full field of view of the user so that the user is “immersed” in the image. Immersive media engages the user's peripheral vision to provide a greater sense of presence and/or a stronger feeling of immersion for the user (e.g., a full motion environment). Thus, immersive media provides an image that better represents a “real world”, full environment, or immersive environment image to the user.

Current head mounted displays are typically front projected displays or direct view displays of an image seen by the eye. These head mounted displays may display stereoscopic images but the images typically have a limited and fixed field of view. Some head mounted displays (e.g., head mounted displays developed for the military) provide a wider field of view (e.g., up to about 150°) based on tiling of the displays but these displays are bulky and can be very expensive. Neck fatigue due to weight may not be an issue in zero gravity applications but inertia effects remain due to mass. These inertia effects may be disconcerting to the user and cause fatigue problems for the user. Currently, there is a need for lightweight, high resolution, wide field of view head mounted display systems.

### SUMMARY

Certain embodiments describe a head mounted display system and methods for using the system. The head mounted display system may include a frame. The frame may be coupled to a head of a user. A projector may be coupled to the frame. The projector head may provide an image. A screen may be coupled to the frame. The screen may display the image to the user. The image displayed on the screen may be a stereoscopic image. The screen may display the image with a field of view of at least about 120° and/or with HDTV resolution. A mirror may be coupled to the frame. The mirror may reflect the image provided by the projector head onto the screen. Optics such as contact lenses or glasses may be used to allow the user's eyes to focus on the image displayed on the screen.

In some embodiments, the system uses folded optics to display the image provided by the projector head onto the screen by reflecting the image in the mirror. In some embodiments, the screen is a diffusion screen. The screen may be a hemispherical screen.

In some embodiments, the screen and the mirror are coupled to the frame so that the screen and mirror can be moved out of the field of view of the user when the system is not in use. In certain embodiments, the screen is removably coupled to the frame. The screen may be removably coupled to the frame so that the screen can be replaced with a different screen.

In some embodiments, the projector head provides a modified image of an original image. The screen may modify the modified image and display the original image to the user.

In certain embodiments, the projector head is coupled to a projector controller. The projector controller may provide video signals to the projector head. The projector controller may be located off the head of the user.

In some embodiments, the projector head is located off of the user's head. For example, the projector head may be a desktop mounted projector head or a laptop mounted projector head. In some embodiments, the projector head is coupled to the projector controller off of the user's head.

In some embodiments, the display system may be used while submerged in water.

### BRIEF DESCRIPTION OF THE DRAWINGS

Advantages of the present invention may become apparent to those skilled in the art with the benefit of the following detailed description and upon reference to the accompanying drawings in which:

FIG. 1 depicts an embodiment of a head mounted display system.

FIG. 1A depicts an embodiment of a projector head attached to a projector controller.

FIG. 2 depicts an embodiment of a head mounted display system with two projector heads.

FIG. 3 depicts an embodiment of a head mounted display system with a flat screen.

FIG. 4 depicts an example of a single composite image.

FIG. 5 depicts an example of the effects of viewing angle on a curved screen.

FIG. 6 depicts resolution (arc min/pixel) versus viewing angle from center (degrees) for several types of screens.

FIG. 7 depicts an embodiment of a head mounted display system using a cap with the mirror in a stored position.

FIG. 8 depicts an embodiment of a head mounted display system using a cap with the mirror in a reflecting position.

FIG. 9 depicts an alternative view of an embodiment of a head mounted display system using a cap with the mirror in a reflecting position.

FIG. 10 depicts an embodiment of a display system with a projector head located under the brim of a cap.

FIG. 11 depicts an embodiment of a display system with two projector heads located under the brim of a cap.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION

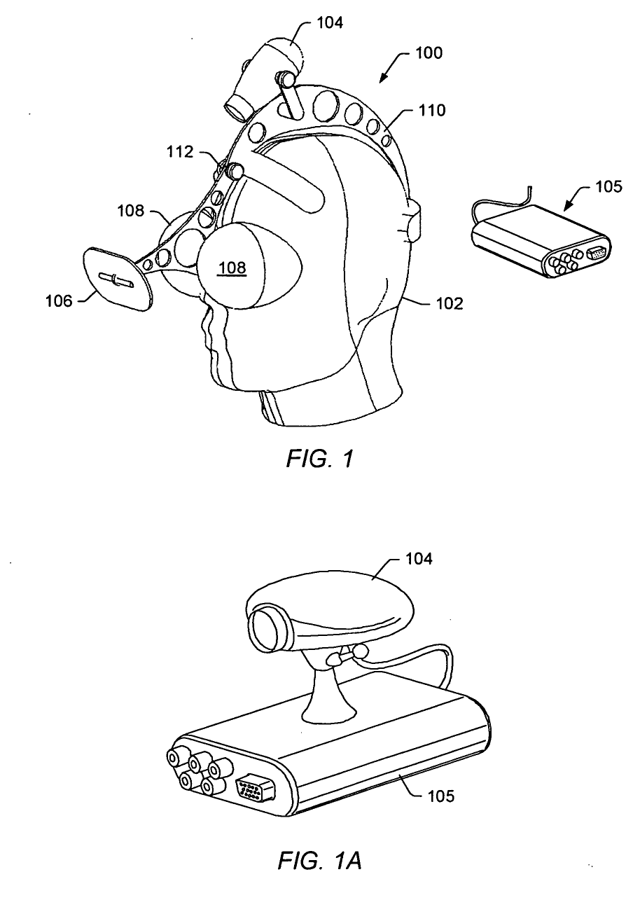

FIG. 1 depicts an embodiment of head mounted projected display system 100. In certain embodiments, display system 100 includes projector head 104, projector controller 105, mirror 106, and screen 108. Projector head 104, mirror 106, and/or screen 108 may be coupled to (e.g., attached to) frame 110. Projector head 104, mirror 106, and/or screen 108 may be removably coupled to frame 110 (e.g., they can be uncoupled from the frame and recoupled to the frame as needed). In certain embodiments, frame 110, projector head 104, mirror 106, and screen 108 have a weight of less than about 2 lbs., less than about 3 lbs., or less than about 5 lbs.

Display system 100 may be coupled to (e.g., mounted on) human head 102 using frame 110. Display system 100 is coupled to head 102 so that the display system is securely held on the head while the display system is in use. Display system 100 and/or one or more components of the display system (e.g., projector head 104, mirror 106, and/or screen 108) may be removed from head 102 when the display system is not in use.

Frame 110 may have any shape or design that allows display system 100 to fit onto and couple to head 102. Frame 110 may be constructed from plastic or other lightweight materials such as, but not limited to, aluminum, titanium, metal alloys, and/or combinations thereof. Frame 110 may include soft pads or other cushions for mounting the frame on head 102. The soft pads may be made from, for example, memory foam or other materials. The pads may distribute the load of display system 100 evenly on the forehead and back of the head. Frame 110 may be adjustable to allow for different size heads. For example, frame 110 may include one or more adjustable straps for coupling the frame to head 102.

Frame 110 fits onto a user's head 102 so that screen 108 is aligned with the user's eyes. Frame 110 may allow adjustment of positions of projector head 104, mirror 106, and/or screen 108 so that they are properly (e.g., optimally) aligned. For example, projector head 104 may be slidably couple to frame 110 so that the projector head may be repositioned on the frame.

Frame may include hinge 112. Hinge 112 may allow mirror 106 and/or screen 108 to be raised up and allow the user to view his/her normal surroundings. Raising mirror 106 and/or screen 108 also may allow the optics of display system 100 to be adjusted. Projector head 104 may be coupled to frame 110 with a hinge attachment so that the projector head can be tilted to adjust the positioning and/or projection angle of the projector head.

During operation of display system 100, images are projected from projector head 104 to mirror 106. Mirror 106 back-projects the image to screen 108. The back-projected images are viewable to the user's eyes.

In certain embodiments, projector head 104 is mounted on or near the top of the user's head 102. For example, projector head 104 may be mounted above the center of gravity of head 102. Mounting projector head 104 above the center of gravity of head 102 minimizes weight offset of the projector head and reduces turning inertia when the user turns his/her head during use of display system 100.

Projector head 104 includes one or more light sources, lenses, and/or microdisplays that together produce one or more images on screen 108. In certain embodiments, projector head 104 uses LEDs (light emitting diodes) as light sources for the projector head. In some embodiments, projector head 104 uses lasers as light sources for the projector head. LEDs and/or lasers may provide advantages over other light sources. For example, projector heads 104 using LEDS may have advantages such as, but not limited to, long operational lifetime, safe operation, low voltage operation, vivid color output, and/or instantaneous on/off operation for fast switching and/or power up. Projector head 104 may provide relatively little heat output so that cooling issues (e.g., use of a fan for cooling) are reduced or eliminated. In some embodiments, projector head 104 includes a heat sink to reduce the heat output of the projector head. LED based projector heads are available from, or in development by, manufacturers such as, but not limited to, Mitsubishi Digital Electronics America, Inc. (Irvine, Calif.), InFocus® Corporation (Wilsonville, Oreg.), NEC Visual Systems (Itasca, Ill.), and Philips Electronics Co. (New York, N.Y.). LEDs used for projector head 104 may be available from manufacturers such as, but not limited to, Philips Lumileds™ Lighting Company (San Jose, Calif.). One example of an LED projector is a 1080p LED projector.

Projector head 104 may have sufficient light output to provide an image to screen 108. For example, projector head 104 may provide a light output of at least about 5 lumen up to about 10 lumen. In some embodiments, projector head 104 provides light outputs greater than 10 lumen. In certain embodiments, display system 100 is designed so that projector head 104 can be replaced with a higher resolution projector head as such a projector head becomes available (e.g., as higher resolution projector heads are developed). For example, projector head 104 may be replaced with a new higher resolution projector head and the new projector head may work with mirror 106 and screen 108 already in place in display system 100.

Microdisplays used in projector head 104 may include, for example, LCD (liquid crystal display), DLP (digital light processing), and/or LCOS (liquid crystal on silicon) microdisplays. Microdisplays used in projector head 104 may have high resolutions that produced detailed and sharp images. For example, an HDTV microdisplay may have full 1920×1080 HDTV resolution so that display system 100 projects an image with full HDTV resolution. Other resolutions are also possible using display system 100 including, but not limited to, 1024×768 and 1280×720. Microdisplays are available from manufacturers such as, but not limited to, Texas Instruments Inc. (Dallas, Tex.) and SpatiaLight® Inc. (Novato, Calif.).

In certain embodiments, projector controller 105 is in communication with projector head 104. Projector controller 105 may provide images or video signals to projector head 104. Projector controller 105 may control projector head 104. Projector controller 105 may include control electronics and/or signal processing electronics for the projector system (e.g., the projector controller and projector head 104).

Projector controller 105 may include inputs and/or outputs for receiving and/or transmitting video and/or audio signals. For example, projector controller 105 may have input and/or output connections such as, but not limited to, composite video connections, component video connections, S-video connections, DVI (digital visual interface) connections, HDMI (high-definition multimedia interface) connections, Ethernet connections, serial connections, parallel connections, USB ports, Bluetooth® (Bluetooth Sig, Inc. (Bellevue, Wash.)) connections or other wireless connections, RGB connections, RCA or other analog audio connections, digital audio connections (e.g., 5.1 or 6.1 digital audio connections), coaxial audio connections, or optical audio connections.

In certain embodiments, projector controller 105 communicates with projector head 104 through a cable or a wire. The cable may be capable of carrying high-definition digital video signals. In some embodiments, projector controller 105 communicates projector head 104 wirelessly. For example, projector controller 105 may communicate with projector head 104 using Bluetooth® or wireless Ethernet (e.g., wireless G) technology.

In certain embodiments, projector controller 105 is located off of head 102. Projector controller 105 is separated from projector head 104 to allow the control electronics (located in the projector controller) to be separated from the projector head. Thus, only projector head 104 is located on the user's head 102. Having only projector head 104 on the user's head reduces the weight burden on the user's head.

In some embodiments, projector controller 105 is of a size small enough to fit in the user's pocket or a small pack (e.g., the projector controller is hand-held size). In some embodiments, projector controller 105 is coupled to (e.g., clipped on) the user's waist or a waistband.

In some embodiments, projector head 104 provides images to screen 108 while the projector head is located off of head 102 (e.g., the projector head is an off-head projector). For example, projector head 104 may be a placed on a desktop, mounted to a desktop or a laptop computer, mounted on a wall, or otherwise located off the head of the user. In certain embodiments, the off-head projector head provides images to screen 108 using mirror 106. In some embodiments, the off-head projector provides images directly to screen 108.

In some embodiments, projector head 104 is coupled or attached to projector controller 105 for use off of head 102. For example, projector controller 105 may be a base for projector head 104, as shown in FIG. 1A. The user may align his/her head with the off-head projector so that the image appears as desired. In some embodiments, the projector may be mounted such that the projector tracks the user's head movements so that the user continually views the projected images.

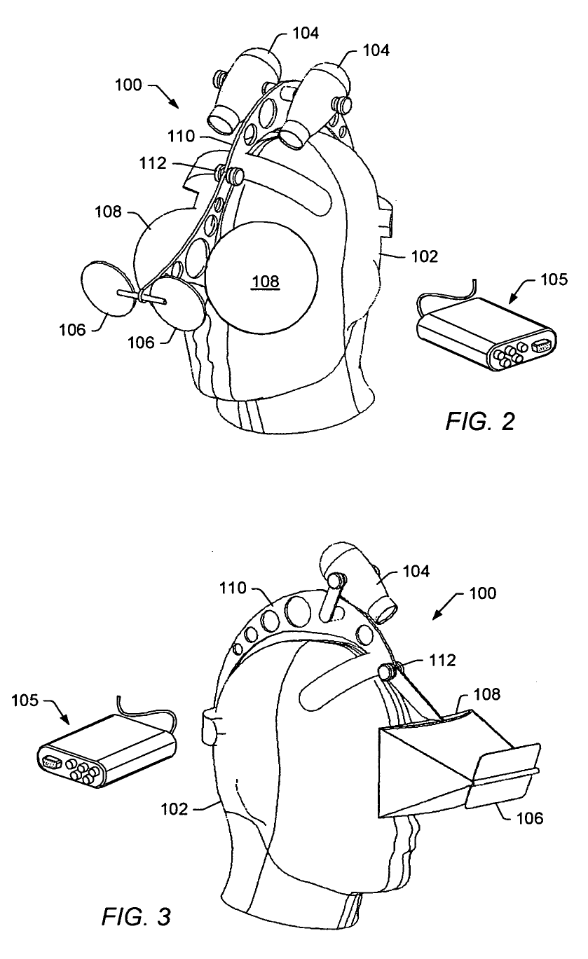

In some embodiments, display system 100 includes more than one projector head 104. For example, display system 100 may include two projector heads, as shown in FIG. 2. Using multiple projector heads 104 may increase the resolution of an image projected on screen 108. For example, as shown in FIG. 2, if each side of screen 108 (e.g., the right eye side and the left eye side) is provided an image from a single projector head 104, the image viewed by the user will have a higher resolution than if one projector head projects the image to both sides of the screen. In certain embodiments, mirror 106 includes separate mirrors for each projector head 104. In some embodiments, mirror 106 is a single mirror used for both projector heads 104. In some embodiments, one or more of the projector heads provide images to screen 108 while the projector head(s) is/are located off of head 102.

In certain embodiments, display system 100 employs folded optics. Using folded optics allows the physical dimensions of display system 100 to be reduced. A suitable path length and cone angle for images displayed in the display system may be maintained using folded optics. Reducing the physical dimensions of display system 100 allows the display system to be a suitable size for mounting on head 102.

As an example, using the embodiment depicted in FIG. 1, display system 100 may require a path length of about 14″ and about a 7° cone angle. Using hemispherical screens for screen 108 allows a field of view of about 166° for each eye. To provide the required path length and maintain a suitable size for mounting on head 102, display system 100 uses mirror 106 to reflect images from projector head 104 onto screen 108. Mirror 106 may include reflective materials and/or have a reflective surface. For example, mirror 106 may be made from a highly reflective Mylar® (E.I. du Pont de Nemours and Company (Wilmington, Del.)) film. In certain embodiments, mirror 106 is made from lightweight reflective materials (e.g., Mylar®) so that the mirror has a low offset weight and a low turning inertia for the user. In some embodiments, mirror 106 is an optical device that has focusing ability. In some embodiments, mirror 106 is a folded mirror or a hinged mirror to correct for intraocular distortions or other image effects. In some embodiments, a portion of frame 110 that supports mirror 106 acts as an optical block to inhibit images projected to the left and right eyes from overlapping.

In some embodiments, software coupled to display system 100 operates or adjusts mirror 106 to correct for intraocular distortions or other image effects. For example, the software may adjust the image provided to projector head 104 to correct for image effects.

In certain embodiments, the reflection angle of mirror 106 is adjustable. Adjusting the angle of mirror 106 may adjust the cone angle of the optics in display system 100 (e.g., the angle of reflection between projector head 104 and screen 108). The angle of mirror 106 may be adjusted to optimize the image viewed on screen 108. For example, the angle of mirror 106 may be adjusted so that the largest and highest resolution image possible is reflected to screen 108.

In certain embodiments, screen 108 is made of clear materials such as polycarbonate or acrylic. Screen 108 may include a diffusion coating on a surface of the screen. For example, screen 108 may have the diffusion coating on an inside surface of the screen. In some embodiments, screen 108 includes microlenses. Microlenses may be approximately the size of a pixel. In some embodiments, screen 108 is made of diffuision materials.

Screen 108 may be located in front of the eyes on head 102 of the user. In certain embodiments, screens 108 are located directly in front of the foveal regions of the user's eyes. In some embodiments, the user wears contact lenses to modify the focal distance of the user's eyes. In some embodiments, screen 108 is designed to allow the user to wear glasses to modify the focal distance of the user's eyes. Wearing contact lenses or glasses may allow the user to focus on the image projected on the screen, which is in close proximity to the user's eyes. In certain embodiments, screen 108 includes lenses or other optics that allow the user's eyes to focus at infinity and/or on the image projected on the screen.

Screen 108 may include a flat screen (as depicted in FIG. 3), one or more hemispherical screens (as depicted in FIGS. 1 and 2), a curved screen, or any other suitable screen shape. A flat screen allows a user to view flat media such as, but not limited to, games, DVDs, and/or HDTV. In some embodiments, the flat screen may include a slight curve (e.g., screen 108 depicted in FIG. 3). The field of view of the flat screen may be about 90°. A curved screen may also be used with flat media to increase the field of view of the screen (e.g., the field of view may be about 120°). A curved screen provides a field of view that is somewhere between the field of view of a flat screen and hemispherical screens. In embodiments using hemispherical screens, one hemispherical screen may be used for each eye, as depicted in FIGS. 1 and 2. Thus, screen 108 may include two hemispherical screens. In some embodiments, screen 108 includes two or more flat screens, two or more curved screens, or two or more hemispherical screens.

In certain embodiments, display system 100 allows a user to remove a screen and replace the screen with another screen (e.g., another type of screen). For example, a user may be allowed to remove a flat screen and replace the flat screen with one or more hemispherical screens. In some embodiments, display system 100 and/or frame 110 includes a hinge device, a quick release device, or other coupling device that allows screen(s) 108 to be coupled to and uncoupled from the display system or frame by the user. Thus, the user may switch back and forth between different types of screens as desired by the user. As an example, the user may wish to initially use display system with a flat screen to learn and grow accustomed to using the display system. After the user grows accustomed to the display system, the user may wish to switch to a hemispherical screen or hemispherical screens to view more involved or immersive images, as described below.

Screens 108 may show images in standard ratios such as a 4:3 ratio or a 16:9 ratio (e.g., an HDTV ratio). A size of image projected on screens 108 may be, for example, about 6×4″ for an HDTV picture. In certain embodiments, display system 100 is designed to allow the user to compensate for inter-pupillary distance (the center-to-center distance between the user's eyes) so that a single image is viewed by the user. For example, display system 100 and/or frame 110 may include a device that adjusts for the inter-pupillary distance of the user. In some embodiments, screens 108 are designed to allow adjustment for the inter-pupillary distance of the user. Screens 108 and/or frame 110 may include a space to allow for the user's nose.

In certain embodiments, screen 108 includes two hemispherical screens, as depicted in FIGS. 1 and 2. Hemispherical screens may be, for example, ellipsoidal or tear-drop shaped. In one embodiment, screen 108 includes hemispherical screens approximately 3″ in diameter. In some embodiments, screen 108 includes hemispherical screens between about 1″ and about 6″ in diameter. Each hemispherical screen is used for one of the user's eyes (e.g., the left hemispherical screen is viewed by the user's left eye and the right hemispherical screen is viewed by the user's right eye). The images viewed on each hemispherical screen are combined by the user's brain into one image (e.g., the user views a stereoscopic image such as an image the user sees through a pair of binoculars). The stereoscopic image may be, for example, an immersive image or a full field of view image (e.g., a more real world like image). The hemispherical screens may present an image that encompasses the entire field of view of the user's eyes. For example, the hemispherical screens may provide the image with a field of view up to approximately 180° to the user. In certain embodiments, the hemispherical screens provide the image with a field of view of at least about 120°, at least about 135°, at least about 150°, or at least about 165° to the user.

Using two hemispherical screens may require the image to be projected to an individual screen as a fisheye image (e.g., a circular image with maximum distortion at the edge of the image) or an otherwise modified or distorted image. The needed modification of the image depends on the shape of the screen. When the modified image is projected onto a hemispherical screen, the projected image wraps itself around the hemispherical wall of the screen (e.g., on the diffusion surface of the screen). Thus, the image engages the peripheral vision of the user's eye on the hemispherical screen and fills the field of view of the user's eye. The image is stretched back to a normal image along the wall of the hemispherical screen. The combined image viewed by the user's brain may have no visible edges and/or no frames so that the combined image is an immersive or virtual image.

The hemispherical screens may be formed or molded to fit the face of the user as closely as possible so that external images are excluded from the user's view as much as possible. Excluding the external images may provide a neutral grey, soft edge to the image viewed by the user. The neutral grey, soft edge may engage the peripheral vision of the user at extreme viewing angles (e.g., viewing angles approaching about 180°).

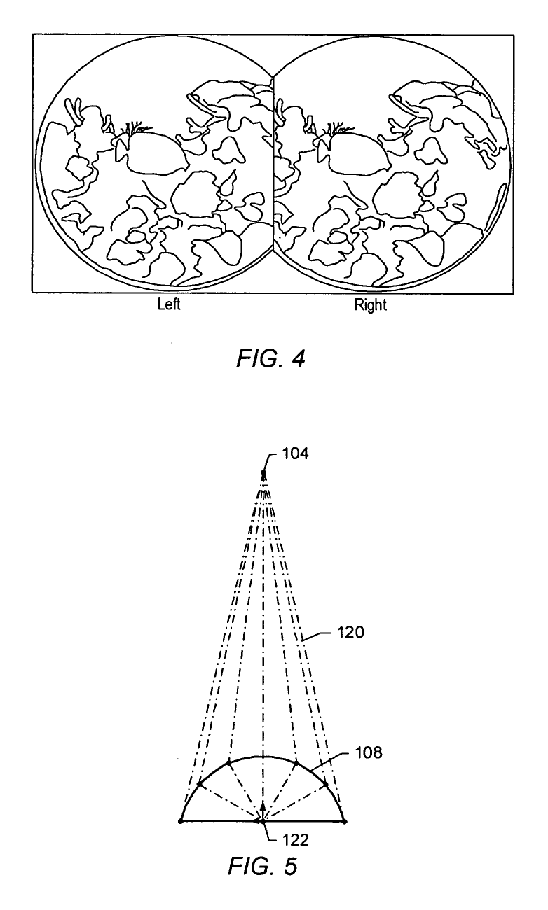

In certain embodiments, software is coupled to, or a part of, display system 100 (e.g., software providing images to projector controller 105 and/or projector head 104). In some embodiments, the software is located on projector controller 105. The software may modify (e.g., distort) an image so that when the modified image is projected on screen 108, the original image is properly viewed by the user. As an example, the software may create a left fisheye image and a right fisheye image from a single image (e.g., a single stereoscopic image) to provide to the left and right hemispherical screens described above. The left and right fisheye images may be combined into a single composite image. An example of the single composite image with left and right fisheye images is depicted in FIG. 4. The single composite image may be a discrete or an overlapping image. The single composite image may maximize the number of pixels used in an image frame. The single composite image maximizes the number of pixels used by using up as much space in the image frame as possible.

This single composite image is provided to projector controller 105 and/or projector head 104, depicted in FIGS. 1 and 2. Projector head 104 provides this image to screen 108. The image is divided between the two hemispherical screens of screen 108 into two separate images that make up the combined single image. These separate images are stretched over the walls of the hemispherical screens so that the user's left and right eyes view two images that are combined by the user's brain into the original image (e.g., the original stereoscopic image). The software may continuously modify images as they are provided to display system 100. For example, the software may run concurrent with a video game or other video source providing images to the display system. In some embodiments, the original image provided to display system 100 may be provided as a properly modified image so that the user views a stereoscopic image.

The image viewed by the user's eye may have a higher resolution in the center of the image compared to the peripheral edges of the image. A user's eye typically is primarily focused on or about the central 25° of the image. The center of the image is where the eye has the greatest acuity. In the peripheral vision of the eye, acuity is less important as the eye tends to detect presence more than acuity. Thus, the lower resolution on the peripheral edges of the image may not be detrimental to the viewing of the image by the user's eye. Having the peripheral edges of the image viewable to the user's eye, even at lower resolution, may provide a more immersive image than a narrow field of view image (e.g., an image with a field of view of less than about 120°). Engaging the presence of the user's peripheral vision with a full field of view image may provide a greater sense of presence and/or a stronger feeling of immersion.

FIG. 5 depicts an example of the effects of viewing angle on a curved screen. Projector head 104 projects an image (represented by cone 120) onto hemispherical screen 108. User's eye 122 is at a center of the arc of screen 108. Eye 122 may be slightly forward of the center of the arc so that the image fills the field of view because of the tangency of the projected image to the arc of screen 108. When the image hits screen 108, the image stretches or wraps around the surface of the hemispheric screen. As the viewing angle of eye 122 increases, the image has to stretch more and the pixels become correspondingly larger (e.g., lower resolution pixels).

This lower resolution at increased viewing angle matches the way eye 122 normally sees. A central region of screen 108 has the highest resolution. This central region corresponds to the foveal region of eye 122. The lower resolution regions at higher viewing angles correspond to the peripheral vision dominant regions of eye 122. Thus, projector head 104 may be a standard (e.g., flat image projector head without adaptive or custom lenses) that matches the way eye 122 views images by projecting a modified (e.g., fisheye) image onto screen 108. The image is stretched or uncompressed back to normal dimensions on screen 108 so that the user views a full field of view stereoscopic image.

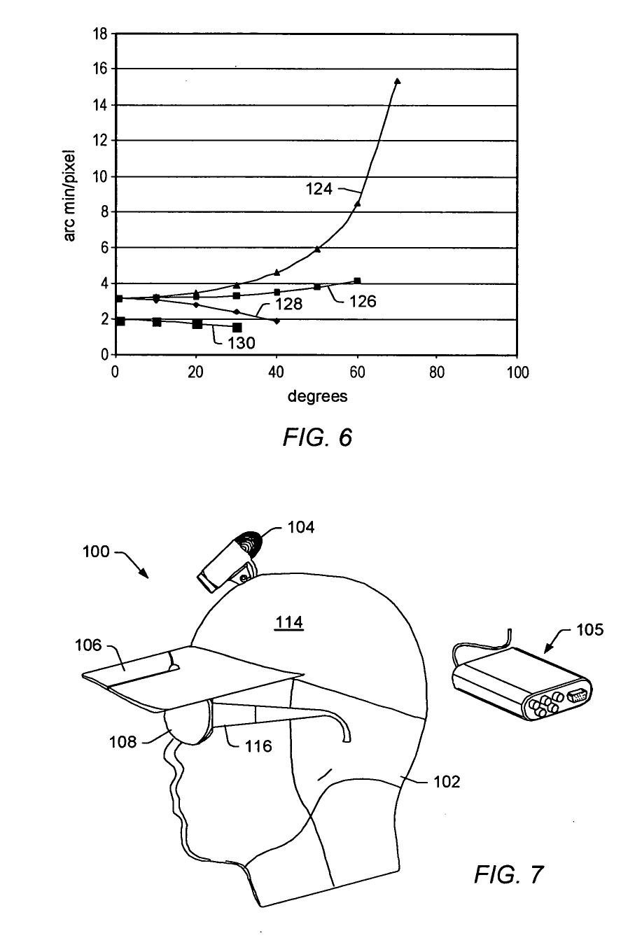

FIG. 6 depicts resolution (arc min/pixel) versus viewing angle from center (degrees) for several types of screens. Resolution decreases as the value of arc min/pixel increases (e.g., resolution decreases going upwards in the graph). Curve 124 depicts resolution using a hemispherical screen. Curve 126 depicts resolution using a curved screen. Curve 128 depicts resolution using a flat screen at 2″ from the eye. Curve 130 depicts resolution using the same flat screen as curve 128 at 3″ from the eye.

Curve 124 shows that resolution is sharpest (about 3 arc min/pixel) at the center viewing angle (0°). Resolution for curve 124 decreases to about 4 arc min/pixel at a viewing angle of 30° from normal (the equivalent of a 60° field of view). At 60° (120° field of view), the resolution is about 8 arc min/pixel. The resolution continues to decrease out to 90° (180° field of view), where the theoretical resolution is infinitely small. In actuality, the last few pixels at 90° viewing angle are not seen by the eye.

Curve 126 shows that resolution slightly decreases up to a viewing angle of about 60° (120° field of view). The resolution is infinitely small (e.g., there are no pixels seen or no image) beyond the viewing angle of 60° for the curved screen. Curves 128 and 130 show that the resolution increases slightly with viewing angle but that the resolution is infinitely small beyond viewing angles of 40° and 30°, respectively. Thus, a flat screen does not provide an image out to the viewing angles that a hemispherical screen provides.

In certain embodiments, display system 100, depicted in FIGS. 1-3, is used in immersive telepresence applications. Immersive telepresence may allow the user to see what others are seeing and/or watch what others are watching. For example, display system 100 may project immersive images transmitted over the internet or through an intranet. Thus, the display system may project a stereoscopic view of a live event such as, but not limited to, a video game competition, an interactive video game competition, a sporting event, a concert, a business meeting, or a news event.

In some embodiments, display system 100 includes systems or devices for tracking movements of head 102. In certain embodiments, display system 100 includes a transmitter or sensor that allows for tracking the movement of head 102. Software coupled to display system 100 may be able to track head 102 to match the images provided to the display system to the movement of the head. For example, display system 100 may be able to track or indicate movements of head 102 in video game environments so that the video game interacts with the user's head movement.

Display system 100 may be used with external sound devices. External sound devices include, but are not limited to, headphones, computer speakers, and surround sound systems. In some embodiments, the user of display system 100 selects his/her desired sound system.

In some embodiments, display system 100 is waterproof (e.g., submersible in water or other liquids). For example, projector head 104, mirror 106, and/or screen 108 may use water tight seals so that water is inhibited from entering the internals of the components. Screen 108 and/or mirror 106 may be designed as a sealed face mask similar to a diving mask or scuba mask. A cover or other device may be used to allow a path for the images to project through display system 100 while the system is submerged.

A waterproof display system may be used for distraction therapy (e.g., therapy for burn treatment) to minimize the attention to pain while dressings are changed or other therapies are being performed on the user while in a water bath. The waterproof display system may be used by astronauts or other personnel in water tanks for space simulation training and/or isolation training.

In certain embodiments, projector head 104 is mounted to a cap or other normal head covering device such as, but not limited to, a helmet or a headband. FIGS. 7-11 depict an embodiment of display system 100 that include a cap. Cap 114 may be a baseball cap or other cap with some type of brim or other projection over the face of head 102. Projector head 104 may be removably coupled to cap 114. Projector head 104 may be, for example, clipped onto cap 114 during use. Projector head 104 may be unclipped from cap 114 for storage and/or removal of the cap from head 102. In certain embodiments, projector controller 105 is located in the user's pocket, located in a small pack, or coupled to the waist of the user. In some embodiments, projector controller 105 is located in cap 114 or is attached to the cap.

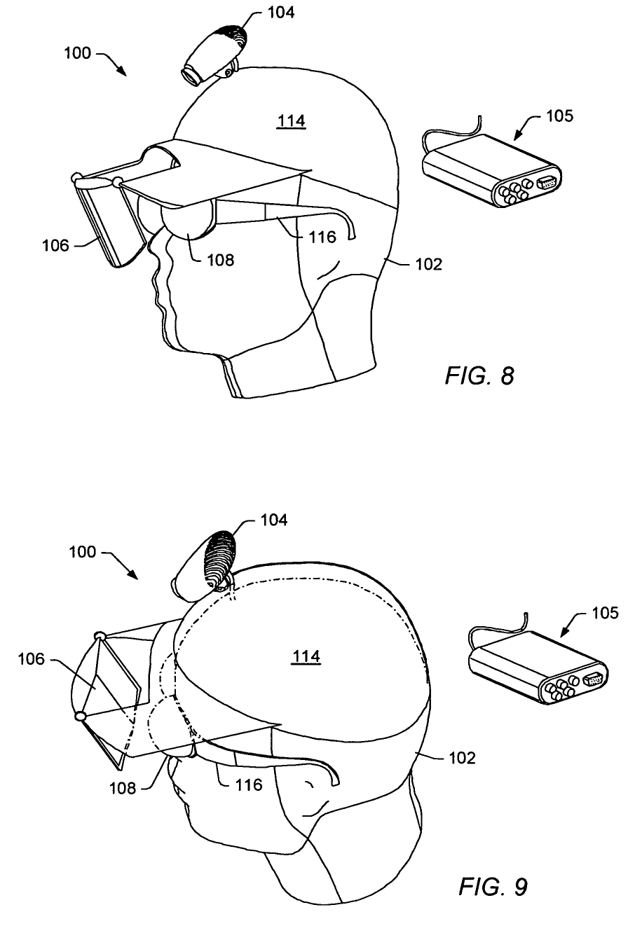

In certain embodiments, mirror 106 is integrated into cap 114. In some embodiments, mirror 106 is integrally formed as a part of cap 114. In some embodiments, mirror 106 is removably coupled to cap 114. Mirror 106 is coupled to and/or integrated cap 114 so that the mirror is stored as a part of the brim of the cap in a stored position when the mirror is not in use, as depicted in FIG. 7. Mirror 106 is made ready for use by moving the mirror to a reflecting position in which the mirror reflects an image from projector head 104 onto screens 108, as depicted in FIGS. 8 and 9. For example, mirror 106 may be pulled forward and downward from the brim of cap 114 into the reflecting position. This movement of mirror 106 also creates an opening for the image to project through the brim of cap 114. Mirror 106 may be a folded mirror, as depicted in FIG. 9, to direct the projected image to the left and right eyes.

In certain embodiments, screens 108 are coupled to eyewear 116, as depicted in FIGS. 7-11. Eyewear 116 may be, for example, goggles or other eyewear that is removably coupled to head 102. In certain embodiments, eyewear 116 and screens 108 encompass the full field of view of the user's eyes so that the user's eyes have little or no view of external images when the eyewear is on head 102. Eyewear 116 may be stored in an eyewear case or other storage device when display system 100 is not in use. In some embodiments, display system includes two or more pieces of eyewear 116. Each piece of eyewear 116 may include a different type of screens 108 (e.g., a flat screen, a curved screen, and/or a hemispherical screen) so that different types of media (e.g., flat media or immersive media) may be viewed using the display system. The user may swap out the different pieces of eyewear 116 to view the media and/or images in a desired manner.

For use of display system 100, mirror 106 is placed in the reflecting position and eyewear 116 is worn by the user. Projector head 104, mirror 106, and/or screens 108 may be adjusted to optically align the components for viewing of the image, as described above. Having the projector head 104 removably coupled to a standard or typical type of headwear (e.g., cap 114) allows the display system to be easily transportable and convenient for the user.

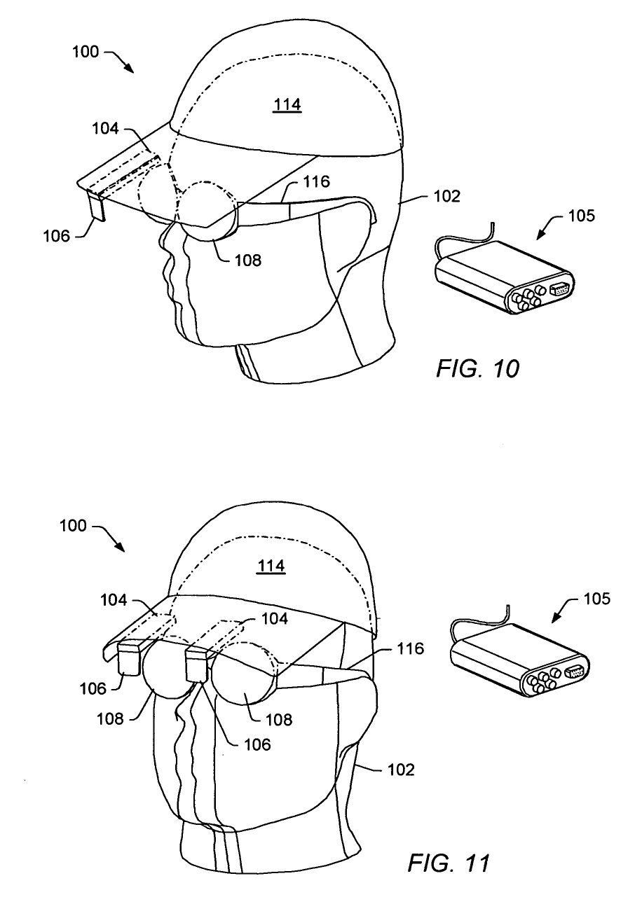

FIG. 10 depicts an embodiment of display system 100 with projector head 104 located under the brim of cap 114. In certain embodiments, projector head 104 is a miniature laser projector head. Projector head 104 may be attached to or integrated into the brim of cap 114. Mirror 106 may also be located under the brim of cap 114. Mirror 106 may be small in size to fit under the brim of cap 114. Mirror 106 may be of a size that does not inhibit the forward vision of the user when the display system is not in use. The brim of cap 114 may shade the display system from overhead light (e.g., sunlight). In some embodiments, two projector heads 104 and two mirrors are used for high resolution images, as depicted in FIG. 11.

Screens 108 may be hemispherical screens, flat screens, curved screens, or other suitably shaped screens. Software or other optical correction mechanisms may be used to adjust the image so that stereoscopic and/or flat images are rendered on screens 108. Thus, screens 108 and eyewear 116 may be designed in a shape desired by the user.

Having projector heads 104 and mirrors 106 underneath the brim of cap 114 allows the upper portions of the cap to be used for other uses such as, but not limited to, advertising or other marketing applications. In some embodiments, heads of projector heads 104 are designed as ornaments or jewelry.

In some embodiments, eyewear 116 and/or screen 108, depicted in FIGS. 1-3 and 7-11, may be used with a projector head that is not coupled to cap 114 or otherwise mounted on head 102. For example, the projector head may be, but not be limited to, a desktop projector, a projector in a computer screen (e.g., a laptop screen), a projector on a table or a wall. The user may wear eyewear 116 and look at the projector directly. Thus, a mirror or other reflective device is not used to project the image onto screens 108. The projector may project an image that is larger than the size of screens 108 so that alignment of screens 108 with the image is easy for the user. Eyewear 116 may be carried around by the user. Thus, the user does not have to carry around a projector or mirrors to use the display system. Eyewear 116 may be used with multiple projectors in multiple locations. In some embodiments, eyewear 116 may be used with a laptop projector so the user can log onto an image provider wherever the user can access the internet.

In certain embodiments, the user may use eyewear 116 to view images from a projector head that displays the same images or unique images to a group of users substantially simultaneously. The projector head may use a plurality of mirrors to distribute the images to the group of users. The projector head may be a single, high resolution projector head or may be several projector heads connected to a single image provider. In some embodiments, the projector head is a laser based projector head that allows the user to move closer to the projector- head to zoom the image without losing his/her focus of the image.

In some embodiments, the projector heads utilize head tracking devices so that the projector head can stay directed at the user within a selected angle. The head tracking device may sense and/or follow a signal in the eyewear worn by the user. Servomotors or other camera moving mechanisms may be used to move the projector head to follow the movement of the user.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A head mounted display system, comprising:
a frame configured to be coupled to a head of a user;
a projector head coupled to the frame, wherein the projector head is configured to provide an image;
a screen coupled to the head of the user, wherein the screen is configured to display the image to the user;
a mirror coupled to the frame, wherein the mirror is configured to reflect the image provided by the projector head onto the screen; and
optics configured to allow the user's eyes to focus on the image displayed on the screen.

2-24. (canceled)

25. A head mounted display system, comprising:
a projector head coupled to the head of a user, wherein the projector head is configured to provide an image;
a screen coupled to the eyes of the user, wherein the screen is configured to display the image to the user's eyes;
a mirror coupled to the head of the user, wherein the mirror is configured to reflect the image provided by the projector head onto the screen; and
optics configured to allow the user's eyes to focus on the image displayed on the screen.

26. A head mounted display system, comprising:
a frame configured to be coupled to a head of a user;
a projector head coupled to the frame, wherein the projector head is configured to provide an image;
a screen coupled to the frame, wherein the screen is configured to display the image to the user, wherein the image displayed on the screen comprises a stereoscopic image, and wherein the screen is configured to display the image with a field of view of at least about 120° and with HDTV resolution;
a mirror coupled to the frame, wherein the mirror is configured to reflect the image provided by the projector head onto the screen; and
optics configured to allow the user's eyes to focus on the image displayed on the screen.

27. A head mounted display system for displaying an original image to a user, comprising:
a frame configured to be coupled to a head of a user;
a projector head coupled to the frame, wherein the projector head is configured to provide a modified image of the original image;
a screen coupled to the frame, wherein the screen is configured to modify the modified image and display the original image to the user;
a mirror coupled to the frame, wherein the mirror is configured to reflect the modified image provided by the projector head onto the screen; and
optics configured to allow the user's eyes to focus on the image displayed on the screen.

28. A head mounted display system, comprising:
a frame configured to be coupled to a head of a user;
a projector head coupled to the frame, wherein the projector head is configured to provide an image;
a screen coupled to the frame, wherein the screen is configured to display the image to the user;
a mirror coupled to the frame, wherein the mirror is configured to reflect the image provided by the projector head so that the image is back-projected onto the screen; and
optics configured to allow the user's eyes to focus on the image displayed on the screen.

29. A method for projecting an image to a user, comprising:
projecting an image using a projector head coupled to the head of the user;
reflecting the image to a screen located in front of the eyes of the user; and
displaying the image on the screen so that the user can view the image.

30-36. (canceled)

37. A head mounted display system, comprising:
a head covering device configured to be coupled to a head of a user;
a projector head configured to be coupled to the head covering device, wherein the projector head is configured to provide an image;
a mirror configured to be coupled to the head covering device, wherein the mirror is configured to reflect the image provided by the projector head onto a screen;
the screen configured to be located proximate the eye of the user, wherein the screen is configured to display the image to the user; and
optics configured to allow the user's eyes to focus on the image displayed on the screen.

38. The system of claim 37, wherein the screen is coupled to eyewear, the eyewear being configured to be removably coupled to the head of the user.

39. The system of claim 37, further comprising a projector controller, wherein the projector controller is coupled to the projector head, and the projector controller is located off the head of the user.

40. The system of claim 37, wherein the mirror is configured to be integrated into the brim of the head covering device in a stored position when the system is not in use.

41. The system of claim 37, wherein the mirror is configured to be moved into a reflecting position by the user when the system is in use.

42. The system of claim 41, wherein the mirror is coupled to the head covering device when the system is in use.

43. The system of claim 41, wherein the mirror is configured to be moved into the reflecting position by sliding and rotating the mirror into the reflecting position.

44. The system of claim 41, wherein the brim of the head covering device comprises an opening allowing projection of light through the opening when the mirror is in the reflecting position.

45. The system of claim 37, wherein the projector head is removably coupled to the head covering device.

46. The system of claim 37, wherein the projector head is removably coupled to the head covering device, and the projector head is configured to be used off the head of the user to provide the image to the screen.

47. The system of claim 37, wherein the optics are coupled to the eyes of the user.

48. A head mounted display system, comprising:
a head covering device configured to be coupled to a head of a user;
a projector head configured to be coupled to and located under the brim of the head covering device, wherein the projector head is configured to provide an image;
a mirror configured to be coupled to and located under the brim of the head covering device, wherein the mirror is configured to reflect the image provided by the projector head onto a screen;
the screen configured to be located proximate the eye of the user, wherein the screen is configured to display the image to the user; and
optics configured to allow the user's eyes to focus on the image displayed on the screen.

49-51. (canceled)

52. A head mounted display system, comprising:
eyewear configured to be removably coupled to a head of a user;
a screen coupled to the eyewear, the screen being configured to be located proximate the eye of the user, wherein the screen is configured to display an image to the user; and
optics configured to allow the user's eyes to focus on the image displayed on the screen;
wherein the image is projected to the screen from a projector head located away from the head of the user.

53-55. (canceled)
